(19) United States
(12) Patent Application Publication
(10) Pub. No.: US 2002/0025816 A1
(43) Pub. Date: Feb. 28, 2002

(54) Method and device in a cellular radio system

(76) Inventors: Lars B. Johansson, Linkoping (SE); Peter Butovitsch, Bromma (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/858,562

(22) Filed: May 17, 2001

(30) Foreign Application Priority Data
May 18, 2000 (SE) 0001839-0

(51) Int. Cl. H04Q 7/20

(52) U.S. Cl. 455/436; 455/442; 455/453

(57) ABSTRACT

A method and a system for handling handovers in a cellular radio system where a mobile terminal (40), having a connection to at least one first base station (42), is about to establish a new connection to a second base station (41).

According to the invention the method comprises the steps:

determining a priority value indicative of a priority assigned to the connection between the mobile terminal (40) and the at least one first base station (42);

deciding from the priority value which type of handover the mobile terminal (40) should be exposed to;

performing the decided handover.

### TECHNICAL FIELD OF THE INVENTION

The present invention relates to a method for handling handovers in a cellular radio system where a mobile terminal, having a connection to at least one first base station, is about to establish a new connection to a second base station.

It also relates to a device for handling handovers in a cellular radio system where a mobile terminal, having a connection to at least one first base station, is about to establish a new connection to a second base station, the at least two base stations being connected to the network via at least one node.

Furthermore it relates to a node in a network in a cellular radio system, the node being connectable to at least one base station, which can connect to and receive branches of signals from at least one mobile terminal.

The invention also relates to a mobile communication network comprising base stations.

### RELATED ART

Code Division Multiple Access (CDMA) is a multiple access method that is based on spread spectrum technique. It is applied in cellular radio systems in addition to the FDMA (Frequency Division Multiple Access) and TDMA (Time Division Multiple Access) methods. In the CDMA method the narrow-band data signal from the user is multiplied to a relatively wide band by a spreading code. The CDMA technique enables all users to transmit on the same frequency simultaneously. A separate spreading code is used for each connection between a base station and a mobile station, and the signals of the different users can be distinguished from one another in the receivers on the basis of the spreading code of each user. The data signal is restored in the receiver to the original band by multiplying it again by the same spreading code that was used during the transmission. To avoid the signals disturbing each other the codes allocated to the downlinks (radio links from base station to mobile terminal) from each base station are typically, mutually orthogonal.

The number of orthogonal codes is however limited and the number is dependent on the data rate. When the average used data rate increases in a cell the number of available orthogonal codes decreases.

Thus, a base station has limited resources regarding codes that can be used in the downlink direction. The base station may also have limited resources regarding the total amount of transmitted power and regarding the signal processing resources required for transmitting and receiving.

When a user enters a new cell in a CDMA-system the handover from the first base station to the base station of the entered cell can be performed in, in principal, two ways. The normal way in CDMA-systems is a soft handover where the mobile station stays on the original frequency and adds towards the new base station another branch, which uses the same frequency as the original branch. During soft handover the mobile station keeps the “old” branch/branches so that it has at least two branches to different base stations. Another way to enter a new cell is via hard handover. This means that the branch used before the handover is dropped when a new branch to a new base station is added. The new branch can have a different frequency from the first used branch, but the frequencies can also be the same. Thus a frequency shift is possible for the hard handover.

In the co-pending US-application with application number U.S. Ser. No. 09/461.030 soft and hard handover in a CDMA-system is described.

One problem with the hard handover is that during the shift to a new branch and maybe to a new frequency, the quality of the connection may decrease or the connection may even be broken.

### SUMMARY

The object of the invention is to increase the reliability of connections in a cellular radio system.

This is achieved by a method of the initially defined kind, comprising the steps described hereafter. The first step is determining a priority value indicative of a priority assigned to the connection between the mobile terminal and the at least one first base station. The next step is deciding from the priority value which type of handover the mobile terminal should be exposed to and then the decided type of handover is performed.

It is also achieved by a device of the initially defined kind characterised in that the device is arranged to be placed in the node. The device comprises determining means for determining a priority value indicative of a priority assigned to the at least one connection between the mobile terminal and the at least one first base station. It comprises also controlling means, connected to the determining means, adapted to make a decision according to the determined priority value about which type of handover this connection should be exposed to and to perform the handover.

Furthermore it is achieved by a node of the initially defined kind, characterised in that it comprises such a device.

It is also achieved by a mobile communication network of the initially defined kind, characterised in that the base stations is connected to the network through such a node.

This method, device, node and mobile communication network ensure that there will not be any unnecessary quality degradations of the connections and that high priority connections not will be exposed to hard handovers if connections with lower priority instead could be exposed to hard handovers.

Preferably the method comprises monitoring by monitoring means the frequencies used for the connections between the mobile terminals and the base stations to determine when there is, or is about to be, a congestion in a used frequency. Suitably it comprises also deciding, in the controlling means connected to the monitoring means, from the information about the status of the frequencies together with the information about the priority value of the connection which type of handover the mobile terminal should be exposed to. Hereby the statuses of the different frequencies are considered when deciding about type of handover.

Suitably the determining step is performed in a node connected to the base stations.

The monitoring of the frequencies, the deciding of which type of handover and the performing of the handover are preferably controlled from the node.

The method comprises preferably sending, from a Home Location Register (HLR) connected to the node, information about which type of customer the at least one concerned subscriber is. This information is suitably received in the node in receiving means and the information is preferable used in the determining of a value indicative of the priority assigned to the at least one subscriber. Thus the determining means suitably is connected to the receiving means.

Preferable the method comprises using information about which type of service the subscriber uses in the determining of a value indicative of the priority assigned to the at least one connection.

The deciding step could comprise deciding in the controlling means whether the handover should be a hard or soft handover.

Preferably the node is a Radio Network Controller (RNC).

Suitably the network is adapted to operate according to the CDMA technique.

### BRIEF DESCRIPTION OF THE DRAWINGS

FIG. 1 shows schematically a mobile terminal, which is in contact with three base stations.

FIG. 2 shows schematically the mobile terminal in FIG. 1.

FIG. 3 shows a mobile terminal connected to three base stations, which are connected to a network.

### DETAILED DESCRIPTION OF EMBODIMENTS

In a CDMA-system mobile terminals receive and combine branches from many base stations at the same time. This is possible since different base stations use the same frequency for their branches to one and the same mobile terminal. In the following description each base station corresponds to one cell.

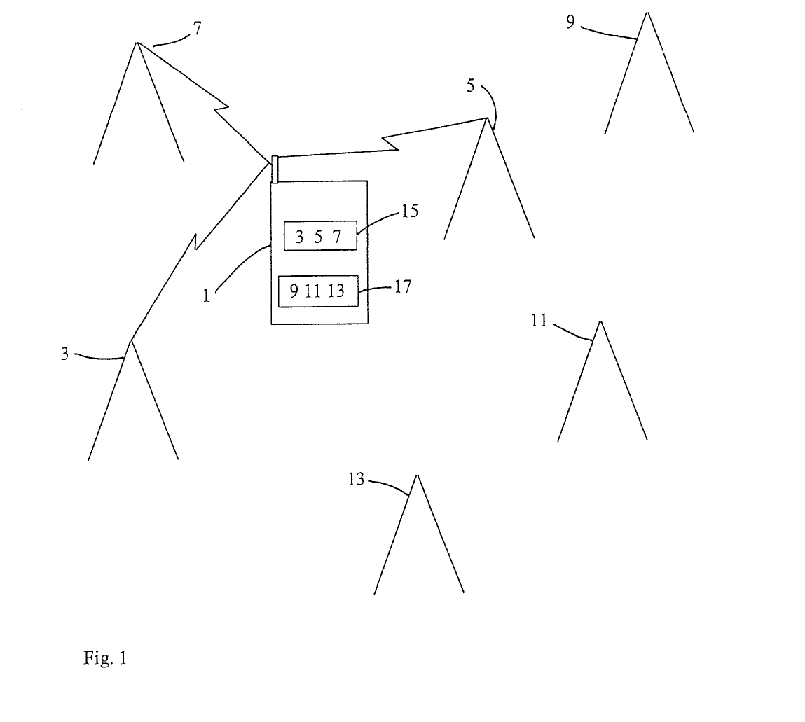

FIG. 1 shows schematically a mobile terminal 1, which has established radio links to a first, a second and a third base station 3, 5 and 7, respectively. There is also shown a fourth, a fifth and a sixth base station 9, 11 and 13, respectively, located relatively near the mobile terminal, but not having established radio links to the mobile terminal 1.

The mobile terminal 1 thus has an active set 15 of base stations 3, 5, 7 from which the mobile terminal 1 receives radio signals and a monitored set 17 of base stations 9, 11, 13 from which the mobile terminal 1 should be ready to receive radio signals. The mobile terminal 1 receives a pilot signal from all base stations in a region around the mobile terminal, this region comprising both the active set 15 and the monitored set 17.

Pilot signals are used in the CDMA system to estimate the quality of the downlinks from the base stations. A pilot signal is a data-unmodulated spreading-coded signal, which is continuously transmitted by each base station to its coverage area. A rake receiver (not shown) in a mobile terminal indicates when it has received power on a specific code corresponding to a pilot signal from a specific base station. The mobile terminal receives these pilot signals from the base stations and reports measurement values to a node, RNC (Radio Network Controller), in the network connected to the base stations. The node uses the pilot signal measurements to instruct the mobile terminal to receive or not receive downlinks from the different base stations. The pilot signals giving the strongest measurement values form the active set 15 of the base stations 3, 5, 7 in the mobile terminal. From the base stations 9, 11, 13 comprised in the monitored set 17 the mobile terminal 1 receives nothing but these pilot signals.

The rake receiver in each mobile terminal continuously measures pilot signals. Each rake receiver maintains a measurement list of the base stations and the corresponding spreading codes of the pilot signals that are situated near the mobile terminal and that are possible candidates for handover or connection establishment. The base stations on the measurement list form a group of candidates, which may become members of the active set.

When a mobile terminal moves, the measurement list is updated. The rake receiver receives radio signals from a new base station when the RNC instructs the mobile terminal to do so. The instructions from the RNC are based on the strengths of the pilot signals received in the mobile terminal.

The mobile terminal repeatedly sends information to the base stations about, for example, how strong the different received pilot signals are. This information could be sent periodically or only when a change in the signal has been recorded. The information is forwarded from the base stations to the RNC. The RNC also knows the sending effect of the pilot signals and thus it knows the attenuation between the base station and the mobile terminal for each downlink (radio links from the base stations to the mobile terminals). It can thus from this information derive which downlinks that are most important in the different connections.

Accordingly, in FIG. 1, the base stations 3, 5, 7 in the active set 15 are located “close” to the mobile terminal 1 and the base stations 9, 11, 13 in the monitored set 17 are located “next” to the active set base stations. This “close” and “next” corresponds rather to the needed power for a good connection than to a geographical distance. When the mobile terminal moves some of the monitored set base stations 9, 11, 13 are moved from the monitored set 17 to the active set 15 and vice versa. Both sets 15, 17 are thus currently updated as the mobile 1 moves between the cells of the base stations.

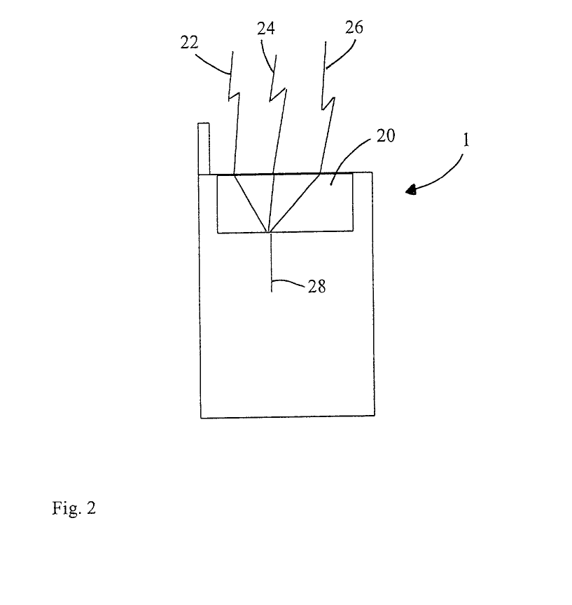

FIG. 2 shows schematically the mobile terminal 1 in FIG. 1. The mobile terminal 1 comprises a rake receiver 20. A similar device is placed in all mobile terminals and also in each base station. The rake receiver 20 receives radio signals 22, 24 and 26, respectively, from the base stations 3, 5 and 7, respectively, (see FIG. 1) that are comprised in the above-mentioned active set 15. These signals 22, 24, 26 have each different codes. The rake receiver 20 decodes the signals 22, 24, 26 and combines them into one signal 28. The fact that the end signal 28 is combined from many signals 22, 24, 26 gives an increased signal quality thanks to diversity. The signal from one base station is also divided into many radio paths during the transmission between the base station and the rake receiver due to reflections. The different radio paths will propagate along different paths and thus they will arrive at the rake receiver 20 in different times. The rake receiver 20 combines also these radio paths and quality in the connection is once again gained because of diversity.

As mentioned above there are in principal two ways for handover in a CDMA system. The normal way in CDMA is soft handover. During a soft handover the mobile terminal connects to a new base station without dropping the previous connections. The mobile terminal is thus connected to more than one base station at the same time. The other way is hard handover where the first branch is dropped when a new is added to the new base station. The hard handover normally involves a frequency shift. The soft and hard handovers can also be combined in different ways. For example a handover could be performed as a soft handover but almost immediately after the soft handover the first branch is removed and the new branch is moved to another frequency. These combined methods will hereafter be included in the expression hard handover.

A hard handover is sometimes needed when the first used frequency is, or is about to be, congested in the cell the mobile station is about to leave. A hard handover with a frequency shift is needed when the first used frequency is, or is about to be, congested in the cell the mobile terminal is about to enter.

The decisions of when a mobile terminal should make a handover and if the mobile terminal that should make a hard or soft handover are taken by the RNC connected to the base stations. The factors that are considered for these decisions are for example how many base stations the different mobile terminals are connected to, reported noise level from the mobile terminals and maybe the resource situation in the different base stations.

According to the invention different types of connections should be treated differently. The different connections should be divided into different priority groups. The high priority connections should not be exposed to hard handovers if a low priority connection instead could make a hard handover since there is a risk of a decreased quality during the hard handover.

The division into different priority groups could be based on different facts. One possibility is to divide the subscribers into different priority groups depending on how good customers they are or how much they pay, i.e. which category of customer they belong to. The priority division could also be based on how the different connections, depending on which type of service they are using, are influenced by a hard handover or, also the other way around, how the system is influenced by a hard handover of a certain service. This means that different types of services are placed in different priority groups. Packet users should for example be placed in a low priority group since they will not experience any extra disturbance due to a hard handover. It is also possible to decide that all connections using a certain service, i.e. packet users, should make hard handovers even if soft handover is the normal way for handover in CDMA. Statistics of how frequently the subscriber uses different services may also be used for the division into priority groups. The division may also be based on all these mentioned alternatives, or maybe on some of them.

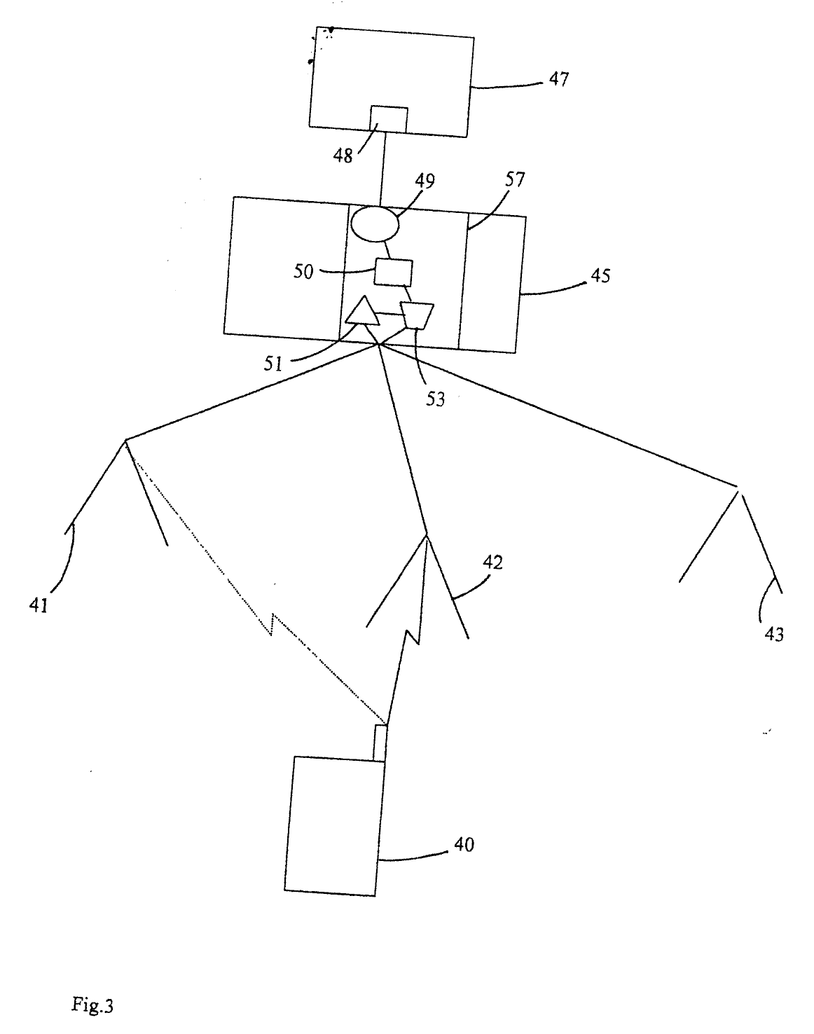

FIG. 3 shows a mobile terminal 40 in contact with a first base station 42. A second and a third base station 41 and 43 respectively are shown in the vicinity of the mobile terminal. The base stations 41, 42, 43 are all connected to a node 45, called RNC, in the network. A Home Location Register (=HLR) 47 located higher in the network is also shown. The RNC 45 comprises, according to the invention, a device 57, here called a priority device.

In the HLR 47 information about every subscriber is stored. This information comprises, according to the invention, which category of customer each subscriber belongs to. There could for example be four categories of customers where the different categories correspond to how the subscribers are prioritised.

When a mobile terminal for the first time enters a cell served by one of the base stations 41, 42, 43 connected to the RNC 45 information about which category of customers this subscriber belongs to is sent by sending means 48 in the HLR 47 to the RNC 45. A receiving means 49 in the priority device 57 in the RNC 45 receives this information. In a determining means 50, connected to the receiving means 49, this information about category of customer and/or information about which type of service the subscriber uses is combined to a resulting value indicative of the priority assigned to the connection. This value could either be a specific value for each connection or one of a predefined number of values corresponding to different priority groups. In a first embodiment of the invention this resulting value is based on a combination of which type of service the subscriber uses and which type of customer it is. In a second embodiment only the information from the HLR 47 about the type of customer is used and in a third embodiment of the invention only the information about which type of service the subscriber uses is used. Also other kind of information could be used to make the prioritisation. For example stored statistics of the subscribers, such as how frequently they use the service, could be used.

The RNC 45 monitors, continuously or repeatedly, by monitoring means 51 the frequencies used by the base stations 41, 42, 43 connected to this RNC 45 to be able to recognise when congestion occurs, or is about to occur, in a frequency. When the mobile terminal 40 is going to establish a new connection to for example the second base station 41 and a handover is to be done, information from the monitoring means 51 about the status of the frequencies together with information from the determining means 50 about the priority of the connection is used in a controlling means 53, connected to the monitoring means 51 and the determining means 50, for making a decision about whether this mobile terminal 40 should make a hard or soft handover to the second base station 41. A hard handover should be done if the priority of the connection is low and/or the currently used frequency for the connection is, or is about to be, congested in the first and/or second base station. The controlling means 53 then performs the handover according to the decision.

The receiving means 49, the determining means 50, the monitoring means 51 and the controlling means 53 are all comprised in the priority device 57 in the RNC 45.

1. A method for handling handovers in a cellular radio system where a mobile terminal (40), having a connection to at least one first base station (42), is about to establish a new connection to a second base station (41), characterised by the steps of:
determining a priority value indicative of a priority assigned to the connection between the mobile terminal (40) and the at least one first base station (42);
deciding from the priority value which type of handover the mobile terminal (40) should be exposed to;
performing the decided handover.

2. A method according to claim 1, characterised by
monitoring the frequencies used for the connections between the mobile terminals (40) and the base stations (41, 42, 43) to determine when there is, or is about to be, a congestion in a used frequency;
deciding from the information about the status of the frequencies together with the information about the priority value of the connection which type of handover the mobile terminal should be exposed to.

3. A method according to claim 1 or 2, characterised in that the determining step is performed in a node (45) connected to the base stations (41, 42, 43).

4. A method according to claim 3, characterised in that the monitoring of the frequencies, the deciding of which type of handover and the performing of the handover are controlled from the node (45).

5. A method according to claim 1 and 2, characterised in that the determining step, the monitoring step, the deciding step and the performing step are carried out or controlled from a node called Radio Network Controller (RNC) (45) in the network connected to the base stations (41, 42, 43).

6. A method according to claim 3 or 4, characterised by
sending, from a Home Location Register (HLR) (47) connected to the node (45), information about which type of customer the at least one concerned subscriber is;
receiving this information in the node (45);
using this information in the determining of a value indicative of the priority assigned to the at least one connection.

7. A method according to any one of the preceding claims, characterised by using information about which type of service the subscriber uses in the determining of a value indicative of the priority assigned to the at least one connection.

8. A method according to any one of the preceding claims, characterised in that the deciding step comprises deciding whether the handover should be a hard or soft handover.

9. A method according to any one of the preceding claims, characterised in that it is performed according to the CDMA technique.

10. A device for handling handovers in a cellular radio system where a mobile terminal (40), having a connection to at least one first base station (42), is about to establish a new connection to a second base station (41), the at least two base stations (41, 42, 43) being connected to the network via at least one node (45), characterised in that the device is arranged to be placed in the node (45) and comprises:
determining means (50) for determining a priority value indicative of a priority assigned to the at least one connection between the mobile terminal (40) and the at least one first base station (42);
controlling means (53), connected to the determining means (50), adapted to make a decision according to the determined priority value about which type of handover this connection should be exposed to and to perform the handover.

11. A device according to claim 10, characterised in that it comprises monitoring means (51) adapted to monitor the frequencies used for the connections between the mobile terminals (40) and the base stations (41, 42, 43) connected to the node (45) to determine when there is, or is about to be, a congestion in a used frequency and in that the controlling means (53) is connected to the monitoring means (51) and is adapted to use the information from the monitoring means (51) about the status of the frequencies together with the information about the priority value for making a decision about which type of handover the connection should be exposed to.

12. A device according to claim 10 or 11, characterised in that it comprises receiving means (49) adapted for receiving, from a Home Location Register (HLR) (47) in the network, information about which type of customer the at least one concerned subscriber is.

13. A device according to claim 12, characterised in that the determining means (50) is connected to the receiving means (49) and is adapted to use the information from the HLR (47) for the determination of a value indicative of the priority assigned to the at least one connection.

14. A device according to any on of the claims 10-13, characterised in that the determining means (50) is adapted to use information about which type of service the subscriber uses when determining a value indicative of the priority assigned to the at least one connection.

15. A device according to any one of the claims 10-14, characterised in that the controlling means (53) is adapted to decide whether the handover should be soft or hard.

16. A node (45) in a network in a cellular radio system, the node (45) being connectable to at least one base station (41, 42, 43), which can connect to and receive branches of signals from at least one mobile terminal (40), characterised in that it comprises a device according to claims 10-15.

17. A node according to claim 16, characterised in that it is a Radio Network Controller (RNC).

18. A mobile communication network comprising base stations (41, 42, 43), characterised in that the base stations (41, 42, 43) are connected to the network through a node (45) according to claim 16 or 17.

19. A mobile communication network according to claim 18, characterised in that the network is adapted to operate according to the CDMA technique.
